(19) United States
(12) Patent Application Publication
(10) Pub. No.: US 2011/0243189 A1
(43) Pub. Date: Oct. 6, 2011

(54) Frequency alignment for narrow band radios

(76) Inventor: LaRoy Wayne Tymes, Monument, CO (US)

(21) Appl. No.: 12/798,303

(22) Filed: Mar. 31, 2010

(51) Int. Cl. H04B 1/00; H04B 1/69

(52) U.S. Cl. 375/132; 375/E01.033

(57) ABSTRACT

A communications protocol that allows the operating frequencies of multiple radios to be aligned, allowing the radios to use a narrower bandwidth than would otherwise be possible.

### BACKGROUND

The present invention relates to aligning frequencies for narrow band radios.

Amateur radio operators have long used Morse code to achieve reliable operation where voice or other modes of communication would not work. Because Morse code is an extreme form of narrow band communication, it has a higher signal to noise ratio than voice, video, or high data rate signals. Morse code will therefore have a longer operating range than these other signals under equal operating conditions.

Recently, wireless sensors and control devices have come into common use Since these devices have very little data to receive or transmit, they would seem to be good candidates for narrow band communication. Unfortunately, since they must be inexpensive for most applications, they cannot afford the luxury of high quality crystal controlled frequency references. The operating frequencies of these radios will be in error because of manufacturing variations, aging, temperature, and other variables.

Suppose a radio transmits to a second radio at a frequency of 1 gigahertz (1,000,000,000 hertz). Suppose further that because of an error in the frequency reference of 1000 parts per million, a second radio is receiving at either 999,000,000 hertz or 1,001,000,000 hertz. To properly receive the signal, the second radio requires a bandwidth of 2,000,000 hertz, plus the bandwidth of the transmitted signal. If the transmitted signal also has an error in its frequency, the receive bandwidth must be even larger. In many cases, the receive bandwidth is determined almost entirely by the need to compensate for frequency error rather than the need to accommodate the bandwidth of the transmitted signal.

For some well established control devices, such as garage door openers, long range is not required or even desired. Garage door openers are not expected to operate through extensive structural barriers or in the presence of high interference. However, many new applications must have a good combination of operating range, structural penetration, and interference rejection, all of which is possible with narrow band communication provided that the operating frequencies of the radios can be aligned.

### SUMMARY

In accordance with the invention, the operating frequencies of two or more radios are aligned with a frequency aligning protocol. One radio transmits at several different frequencies. The frequencies are spaced closely enough together that at least one transmission is received by the one or more receiving radios. Each transmission has within it information correlated with the transmission frequency. The receiving radio(s) uses that information to change its operating frequency to that of a future transmission, enabling the use of a narrower receive bandwidth than would otherwise be possible.

### DRAWING FIGURES

FIG. 1 is a diagram illustrating the prior art method of dealing with errors in frequency alignment.

FIG. 2 is a diagram illustrating a base radio communicating with a sensor radio.

FIG. 3 schematically depicts the frequencies and bandwidth envelopes of 5 slightly overlapping transmissions, together with a receive frequency and bandwidth envelope used for approximate frequency alignment.

FIG. 4 schematically depicts the frequencies and bandwidth envelopes of 5 transmissions closely spaced in frequency.

### DETAILED DESCRIPTION

For the purposes of the following illustrations, the word “radio” may be taken to be an electronic device that transmits and receives information in the form of electromagnetic energy at some frequency. More generally, the word “radio” is intended to mean any device that transmits and receives information in an energy form having a frequency. For instance, a “radio” may be an under water acoustic device that sends and receives information in the form of sound waves through water.

For the purposes of the following illustrations, the phrase “sensor radio” may be taken to be a communication device having a sensor attached to it, such as a temperature sensor. More generally, the phrase “sensor radio” is intended to be a device that sends or receives a small amount of information. For instance, a “sensor radio” may operate a valve or switch in response to received commands. For some applications, a “sensor radio” may have many sensing, control, and other functions.

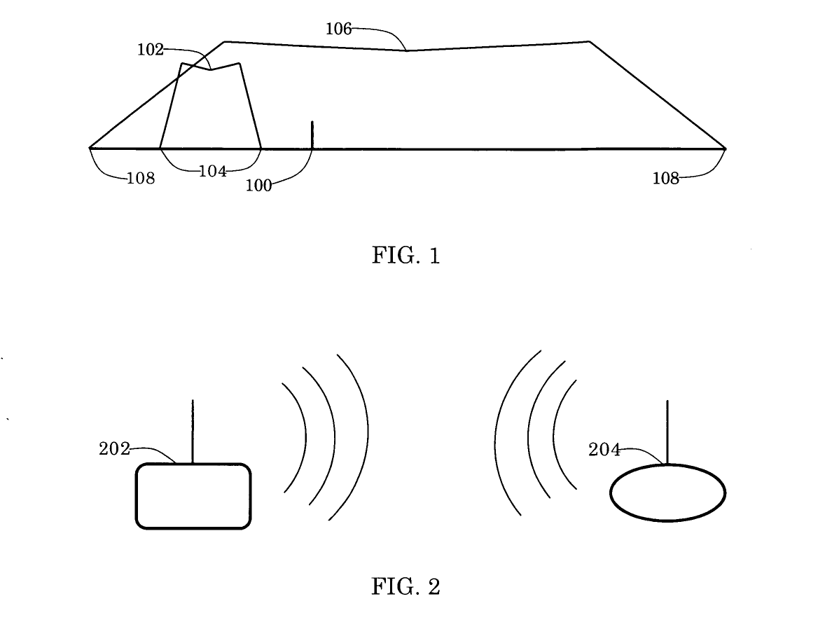

FIG. 1 illustrates the prior art method of dealing with frequency misalignment. 100 is the desired frequency for the communication. 102 is the center operating frequency of the transmitter and 104 is the bandwidth of its transmission. 106 is the operating frequency of the receiver. Frequencies 102 and 106 differ from the desired frequency 100 because of errors in the frequency sources of the transmitter and receiver. 108 is the required bandwidth of the receiver to ensure that all the energy of the transmission is captured. In some cases, the required bandwidth 108 of the receiver may be thousands of times larger than the bandwidth 104 of the transmitter. If both the transmitter and the receiver have very accurate frequency references, then their deviations from the desired frequency 100 can be greatly reduced and the required receiver bandwidth 108 can also be greatly reduced. Alternatively, if the operating frequency 106 of the receiver can be aligned with the operating frequency 102 of the transmitter, the required receiver bandwidth 108 can also be greatly reduced. The first method is expensive. The second method is the object of this invention.

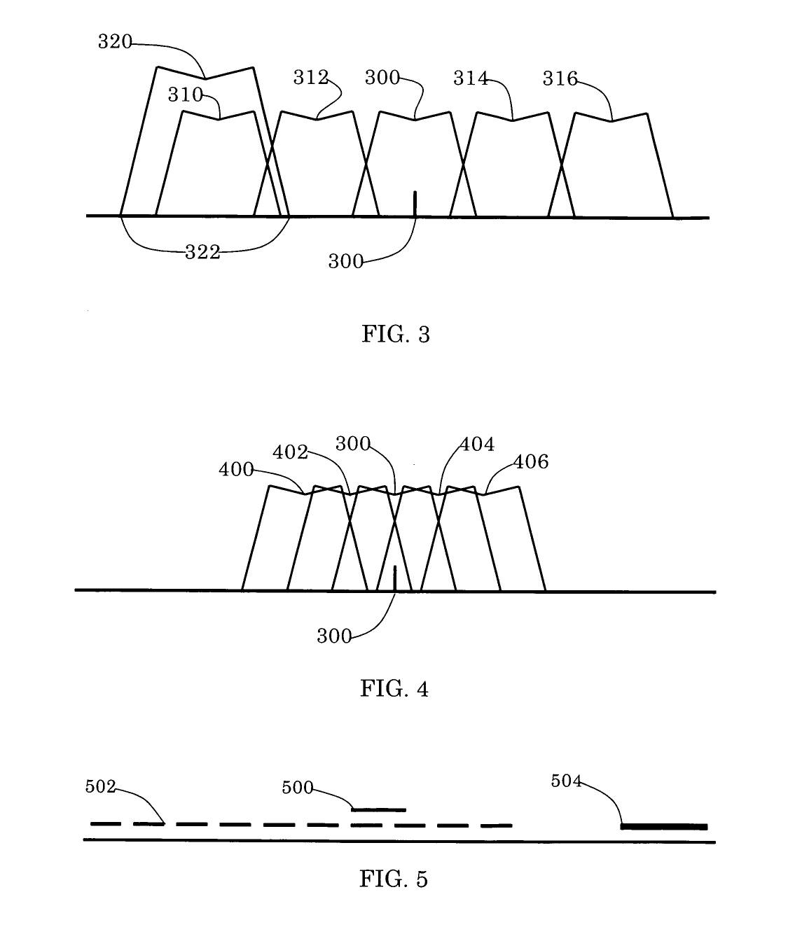

One embodiment of the invention is illustrated in FIGS. 2, 3, 4, and 5. A base radio 202 transmits a packet at a frequency 310 that is 2,000 hertz below a target frequency 300. The packet includes information that the frequency of the transmission is 2,000 hertz below the target frequency. The radio then transmits a packet at a frequency 312 that is 1,000 hertz below the target frequency and includes information that the frequency is 1,000 hertz below the target frequency. The radio subsequently transmits packets at the desired frequency 300, frequency 314 1,000 hertz above, and frequency 316 2,000 hertz above, each packet containing information regarding the difference between its transmission frequency and the desired frequency.

If a sensor radio 204 which is operating at frequency 320 detects the packet transmitted at frequency 310, the sensor radio will increase its operating frequency by 2,000 hertz, based on the information in the received packet, so that its operating frequency will be much closer to the target frequency 300. The sensor radio operates with bandwidth 322 which is sufficient to capture a transmission with a frequency misalignment of 500 hertz. All of the above parameters, including the number of packets, are for illustration only and may be varied over a wide range according to the requirements of a particular application.

In some applications it may be desirable to further refine the frequency of the sensor radio. One method of doing this is for the host radio to make further transmissions with smaller deviations above (404 and 406) and below (400 and 402) the target frequency 300. The sensor radio may receive at least two of these transmissions because they are closely spaced in frequency. The sensor radio may compute a weighted average of the frequency offset information contained in these packets with the weighting being derived from some quality parameter of the transmissions, such as RSSI (Received Signal Strength Indicator), and then make a small adjustment of its operating frequency.

There may be a large number of sensor radios in this embodiment. They may all listen to the base radio transmissions and align their frequencies simultaneously.

In this embodiment, the sensor radios may operate for weeks or months without making any transmission at all. They will remain silent in the absence of a base radio. However, they must keep their receivers on all the time because they never know when a base radio will appear. If they are running on batteries or some other limited form of power, it may be desirable to keep their radios off most of the time. For instance, they may be fully operational for one second 500, then power down for nine seconds. In this case the base radio will make all frequency alignment transmissions within one second, and then repeat the transmissions for the full ten second period 502 to ensure that every sensor radio will receive at least one transmission. In this case, the transmissions have the dual purpose of aligning the frequencies of the sensor radios and alerting the sensor radios that they should come out of their low power mode for some upcoming data communication. As a further refinement, some or all of the packets may contain information regarding how much time will elapse before this communication takes place at time 504 so that a particular sensor radio has the option of powering down until time 504.

In still another variation, the base radio may determine that it is desirable to operate at a frequency far removed from where all the sensor radios are operating. The method in this case is the same, except the difference between the frequency of each frequency alignment transmission and the target frequency is large. When a sensor radio receives such a packet, it will make a correspondingly large adjustment to its operating frequency to change to the target frequency.

In a second embodiment, the roles of the base radio and the sensor radios are reversed. The sensor radios initiate all communication and the base radio is presumed to be always present and ready to respond. An advantage of this embodiment over the previous one is that the sensor radios may remain powered down nearly all the time, powering up only as needed. A disadvantage is that a level of radio traffic is generated all the time. A further disadvantage is that if a sensor radio is powered down for a period of time, it is impossible to get the attention of that radio until it powers up.

There are many variations of the second embodiment. For instance, suppose that a sensor radio is powered down nearly all the time and the base radio is always powered up. If there has never been any communication because the radios have just been activated for the first time, their operating frequencies may be far apart. The sensor radio may transmit a number of frequency alignment packets, each at a different frequency, until it gets a response from the base radio. The response indicates that the two radios are close enough in operating frequency for some communication to occur. Following this coarse alignment, either the sensor radio or the base radio can send a series of packets at slightly different frequencies, each packet containing information identifying the frequency of the transmission. This information could be as simple as a packet number. Assuming that the receiving radio receives a plurality of such packets, such as packet numbers 3, 4, and 5 of a 10 packet sequence, it can use RSSI (Received Signal Strength Indicator) or some other parameter to weight how well each received packet was aligned with its own operating frequency. Given this information, the two radios can negotiate an agreed upon frequency. If there are many sensor radios, the base radio will select a common operating frequency and all sensor radios will move to that common frequency.

Once a common operating frequency has been selected, there is still a problem of frequency drift due to changes in power, temperature, and other variables. To compensate for this drift, a sensor radio may send two test packets, one slightly above and one slightly below what is believed to be the correct frequency. The base radio will respond with a packet indicating how successfully each packet was received. Based on this information, the sensor radio may adjust its frequency for subsequent operation.

The above embodiments assume a base radio communicating with one or more sensor radios. Ad hoc or mesh networks are more complicated to describe, but may use the same principles of hunting, probing, and exchanging information for the purpose of frequency alignment. The optimum implantation details will be strongly affected by the desired power conserving modes. For instance, a network in which all nodes spend nearly all their time powered down will have to synchronize their communication in time as well as frequency.

Modern embodiments often use packets for all communications. However, the invention may also be used for communications that do not use packets.

Spread spectrum communication protocols spread the energy of the transmissions over a much broader band than other protocols and would therefore not seem relevant to the invention. However, one form of spread spectrum communication is frequency hopping, wherein radios communicate on a particular frequency for a short amount of time, then another frequency, and so on in a predetermined pattern of frequencies. Although many frequencies are used and the total bandwidth is therefore large, at any given instant only a small percentage of the total band is used. Frequency hopping radios can therefore benefit from this invention just as non-frequency hopping radios can. Furthermore, the narrower the bandwidths of the radios at any given instant, the more non-overlapping frequencies are available within a given band. Stated another way, if it has been decided that a particular set of non-overlapping frequencies are to be used, this invention can achieve the required frequency alignment with less expensive frequency references than would otherwise be required.

Frequency hopping protocols require synchronization in time so that radios step from one frequency to the next in unison. Synchronization must first be acquired, and then tracked. Both tasks are related to the accuracy of their individual frequency references. It is convenient and efficient to combine the tasks of time synchronization with narrow band frequency alignment. For instance, at the beginning of the first time period for the first of a pattern of frequencies, the base radio may send a beacon at frequency 300 containing all information required for the protocol. One other time period may begin with a smaller beacon at frequency 310 which includes information regarding the difference between its frequency and frequency 300. Still another time period can be used in a similar manner at frequency 316. The base may occasionally transmit packets at frequencies 312 and 314, as well as 400, 402, 404, and 406 solely for the purposes of frequency alignment.

While the invention has been described with reference to a few specific embodiments, the description is illustrative of the invention and is not to be construed as limiting the invention. Various modifications may occur to those skilled in the art without departing from the true spirit and scope of the invention as defined by the appended claims.

I claim:

1. A method of communication, comprising:
transmitting a plurality of transmissions, each of said transmissions being transmitted at a different frequency than the others, and each of said transmissions containing information relating to the frequency of said transmission.

2. The method of claim 1, wherein said transmissions contain information regarding a time at which a future communication will occur.

3. The method of claim 1, wherein a frequency hopping spread spectrum protocol is used for communication.

4. The method of claim 3, wherein said transmissions contain parameters relevant to said frequency hopping spread spectrum protocol.

5. The method of claim 1, wherein the transmission of said plurality of said transmissions is repeated at least once.

6. A propagated signal comprising:
a plurality of transmissions, each of said transmissions being transmitted at a different frequency than the others, and each of said transmissions containing information relating to the frequency of said transmission.

7. The propagated signal of claim 6, wherein said transmissions contain information regarding a time at which a future communication will occur.

8. The propagated signal of claim 6, wherein a frequency hopping spread spectrum protocol is used for communication.

9. The propagated signal of claim 8, wherein said transmissions contain parameters relevant to said frequency hopping spread spectrum protocol.

10. The propagated signal of claim 6, wherein the transmission of said plurality of said transmissions is repeated at least once.

11. An article of manufacture, comprising a machine-accessible medium having instructions encoded thereon for enabling a processor to perform the operation of transmitting a plurality of transmissions, each of said transmission being transmitted at a different frequency than the others, and each of said transmission containing information relating to the frequency of said transmission.

12. The article of manufacture of claim 11, wherein said transmissions contain information regarding a time at which a future communication will occur.

13. The article of manufacture of claim 11, wherein a frequency hopping spread spectrum protocol is used for communication.

14. The article of manufacture of claim 13, wherein said transmissions contain parameters relevant to said frequency hopping spread spectrum protocol.

15. The article of manufacture of claim 11, wherein the transmission of said plurality of said transmissions is repeated at least once.
